(19) United States
(12) Patent Application Publication
(10) Pub. No.: US 2015/0293939 A1
(43) Pub. Date: Oct. 15, 2015

(54) PHOTO MEDIA DISPLAYING METHOD FOR DISPLAYING PHOTO FILES IN AREA NETWORK AND PHOTO MEDIA DISPLAYING SYSTEM

(71) Applicant: Primax Eelectronics Ltd., Taipei (TW)

(72) Inventor: JUNG-CHANG YANG, Taipei (TW)

(21) Appl. No.: 14/312,457

(22) Filed: Jun. 23, 2014

(30) Foreign Application Priority Data
Apr. 11, 2014 (TW) 103113435

(51) Int. Cl. G06F 17/30

(52) U.S. Cl. CPC G06F 17/30253; G06F 17/30274

(57) ABSTRACT

A photo media displaying method for displaying photo files in an area network is provided. Firstly, plural photo files are classified according to at least one business card data of the plural photo files. The photo files with the business card data are assigned to a first virtual folder. The photo files without the business card data are assigned to a second virtual folder. If the first virtual folder is selected, the photo files corresponding to the first virtual folder are displayed on an active control device. If the second virtual folder is selected, the photo files corresponding to the second virtual folder are displayed on the active control device. The photo media displaying method can classify and manage the photo files to facilitate the user to browse the photo files.

### FIELD OF THE INVENTION

The present invention relates to a photo media displaying method, and more particularly to a photo media displaying method for a playing photo files in an area network.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media 15. The media 15 is for example an audio file, a photo file or a video file. After the digital media player 12 is in communication with the digital media server 11, the user may search the media 15 from the digital media server 11 through digital media player 12. After the media 15 is selected by the user through the digital media player 12, the media 15 is transmitted from the digital media server 11 to a second storage element 121 of the digital media player 12. After the media 15 is received by the digital media player 12, the media 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media 25. In addition, the digital media server 21 further provides a control function of controlling operations of the digital media renderer 23. The digital media renderer 23 is used for receiving and playing the media 25 that is transmitted from the digital media server 21. After the control function of the digital media server 21 is utilized to select the stored media 25 from the digital media server 21, the media 25 is transmitted from the digital media server 21 to the digital media renderer 23. Consequently, the media 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media 35. The digital media renderer 33 is used for receiving and playing the media 35 that is transmitted from the digital media server 31. The digital media controller 34 provides a control function. After the control function of the digital media controller 34 is utilized to select the stored media 35 from the digital media server 31, the media 35 is transmitted from the digital media server 31 to the digital media renderer 33. Consequently, the media 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone (i.e. used as the digital media controller or the digital media player) to be connected to a computer host (i.e. used as the digital media server) in a study room. Moreover, through the smart phone, the user may browse the audio files in the computer host and select a desired audio file from the computer host. Then, the selected audio file is transmitted from the smart phone to a stereo device (i.e. used as the digital media renderer) in the living room. After the audio file is received by the stereo set, the audio file is played by the stereo device. Consequently, the purposes of conveniently and quickly sharing media contents can be achieved by the DLNA system.

In case that the first storage element of the digital media server stores a great number of media files, it is difficult to search the desired media file. For example, if the user intends to play the media file of the digital media server through the use of the digital media controller or the digital media player, since the number of the media files is too large, the desired media file to be played cannot be easily searched by the user. For facilitating the user to search the desired media file, at least three folders have been previously stored in the first storage element of the commercially available digital media server. The at least three folders comprise an audio folder corresponding to the audio files, a photo folder corresponding to the photo files and a video folder corresponding to the video files. When an audio file is newly added to the digital media server, the audio file is automatically assigned to the audio folder. Similarly, when a photo file is newly added to the digital media server, the photo file is automatically assigned to the photo folder. Similarly, when a video file is newly added to the digital media server, the video file is automatically assigned to the video folder.

However, since the number of the photo files is much larger than the number of the video file and the number of the audio files, the single photo folder of the first storage element usually stores a great number of photo files. Consequently, if the user intends to view the media file of the digital media server through the use of the digital media controller or the digital media player, it is still difficult for the user to search the desired media file from the photo folder. Especially, it is more difficult for the user to search the photo files corresponding to physical business cards that contain business card data. The photo files corresponding to the physical business cards are photo files that are obtained by capturing or scanning physical business cards. The photo files corresponding to the physical business cards contain various business card data. Generally, the business card data include company trademark information, name information, company name information, professional title information, e-mail information, address information, phone numbers, and fax number information.

For example, for searching a photo file corresponding to a specified company name, the user has to successively browse all photo files in order to judge whether the browsed photo file is a photo file corresponding to the physical business card or not. If the user judges that the browsed photo file is a photo file corresponding to the physical business card, the user has to view the company name in the browsed photo file in order to judge whether the browsed photo file is the target photo file to be searched. In case that the first storage element stores a great number of photo files, the way of successively browsing all photo files is time-consuming and labor-intensive.

Therefore, there is a need of providing a photo media displaying method and a photo media displaying system for facilitating the user to search photo files.

### SUMMARY OF THE INVENTION

An object of the present invention provides a photo media displaying method for facilitating the user to search photo files.

Another object of the present invention provides a photo media displaying system for facilitating the user to search photo files.

In accordance with an aspect of the present invention, there is provided a photo media displaying method for use in an area network. The photo media displaying method includes the following steps. Firstly, a digital media server of the area network judges whether at least one business card data is acquired from plural photo files. Then, the digital media server writes the at least one business card data and plural photo data of the plural photo files into plural metadata of the plural photo files or writes only the plural photo data of the plural photo files into the plural metadata of the plural photo files according to a result of acquiring the at least one business card data. Then, the plural photo files are assigned to a first virtual folder or a second virtual folder of the digital media server according to contents of the at least one business card data. If an active control device of the area network is connected to the digital media server through network connection and the first virtual folder or the second virtual folder is selected, the photo files corresponding to the first virtual folder and the second virtual folder are displayed on the active control device or a digital media renderer of the area network.

In accordance with another aspect of the present invention, there is provided a photo media displaying system. The photo media displaying system includes a network router, a digital media server, and an active control device. The network router provides a network connection function. The digital media server is connected to the network router through network connection and stores plural photo files. The plural photo files are assigned to a first virtual folder or a second virtual folder of the digital media server. The digital media server includes a storage element, a data acquisition module, and a controlling unit. The storage element is disposed within the digital media server or connected with the digital media server. The plural photo files are stored in the storage element. The data acquisition module is connected with the storage element and acquires at least one business card data and plural photo data from the plural photo files. The controlling unit is connected with the storage element and the data acquisition module. According to an acquiring result of the data acquisition module, the controlling unit writes the at least one business card data and the plural photo data into plural metadata of the plural photo files or writes the plural photo data into the plural metadata of the plural photo files, so that the plural photo files are selectively assigned to the first virtual folder or the second virtual folder. The active control device is connected to the network router through network connection and connected to the digital media server via the network router through network connection. The first virtual folder or the second virtual folder is selected through the active control device. If the first virtual folder or the second virtual folder is selected, the photo files corresponding to the first virtual folder or the second virtual folder are retrieved from the digital media server by the active control device or a digital media renderer and displayed on the active control device or the digital media renderer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a photo media displaying system according to a first embodiment of the present invention;

FIG. 5 is a flowchart illustrating a photo media displaying method for displaying photo files in an area network according to a first embodiment of the present invention;

FIG. 6 is a table indicating the metadata of the plural photo files of the photo media displaying system of the present invention;

FIG. 7 schematically illustrates the folder architecture of the digital media server of the photo media displaying system according to the first embodiment of the present invention;

FIG. 8 is a schematic functional block diagram illustrating a photo media displaying system according to a second embodiment of the present invention;

FIG. 9 is a flowchart illustrating a photo media displaying method for displaying photo files in the area network according to a second embodiment of the present invention; and

FIG. 10 schematically illustrates the folder architecture of the digital media server of the photo media displaying system according to the second embodiment of the present invention.

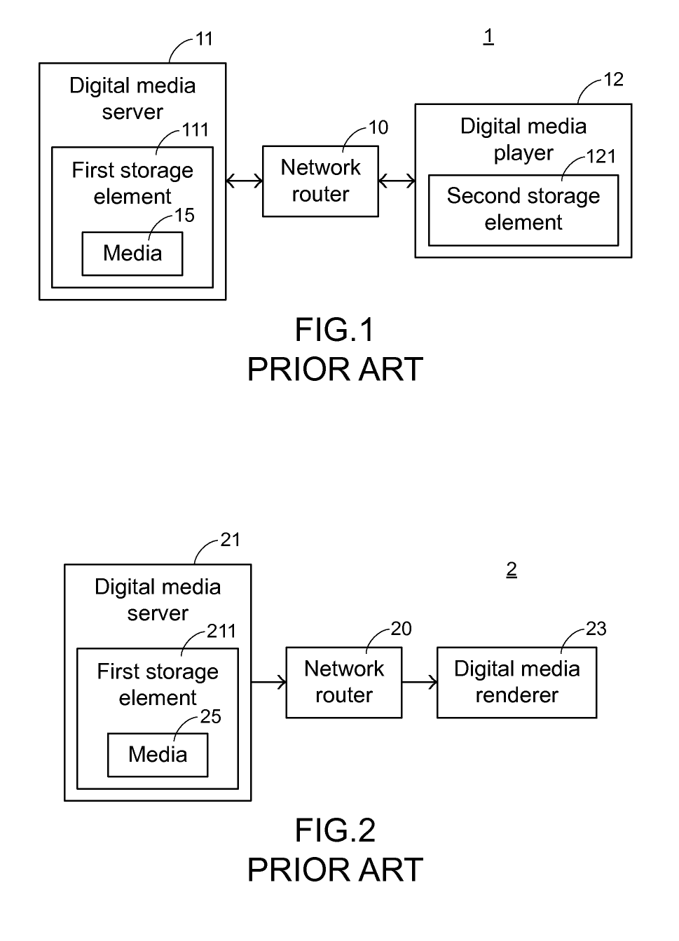

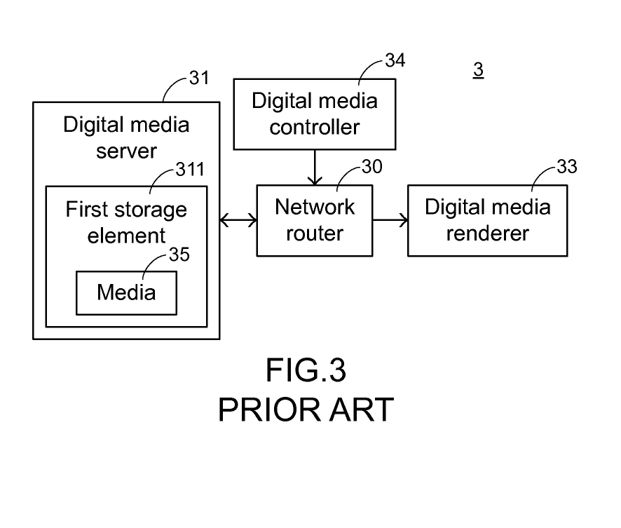

### DETAILED DESCRIPTION OF THE PREFERRED EMBODIMENT

For obviating the drawbacks encountered from the prior art, the present invention provides a photo media displaying method and a photo media displaying system for implementing the photo media displaying method.

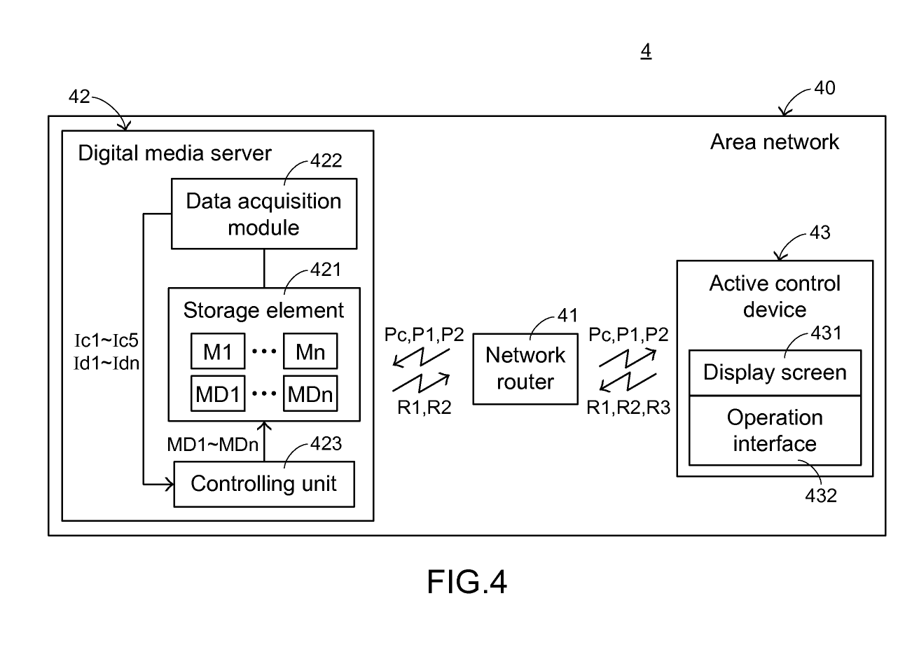

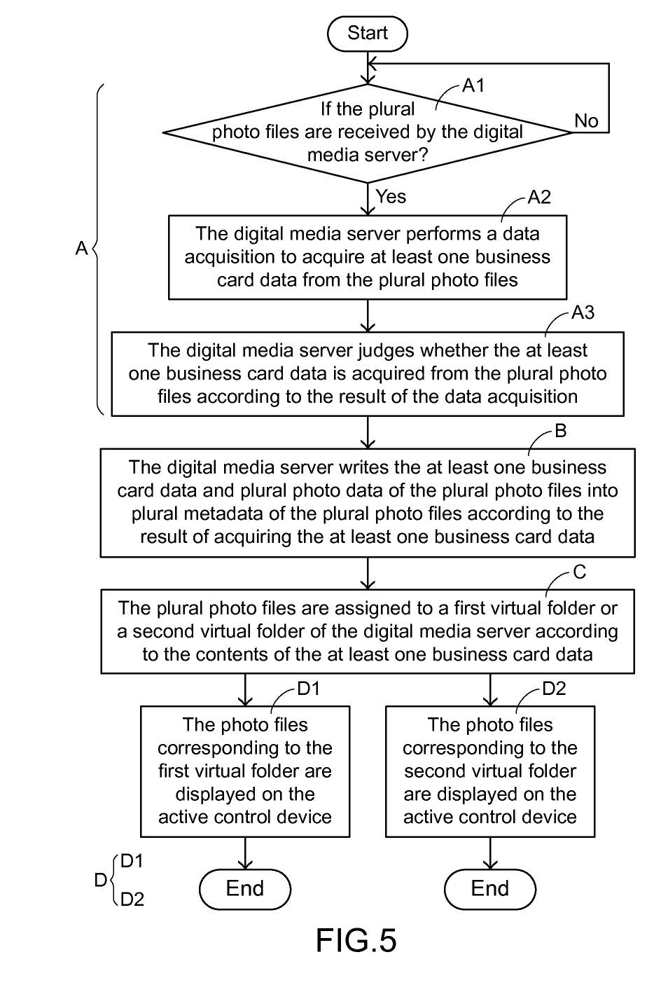

Hereinafter, a photo media displaying system of the present invention will be illustrated. FIG. 4 is a schematic functional block diagram illustrating a photo media displaying system according to a first embodiment of the present invention. As shown in FIG. 4, the photo media displaying system 4 comprises a network router 41, a digital media server 42, and an active control device 43. The digital media server 42 comprises a storage element 421, a data acquisition module 422, and a controlling unit 423. The network router 41 is used to provide a network connection function. Via the network router 41, the digital media server 42 and the active control device 43 are connected with each other through network connection. The digital media server 42 is connected to the network router 41 through network connection. The digital media server 42 has two functions. Firstly, the digital media server 42 may store plural photo files M1˜Mn therein. Secondly, the digital media server 42 may assign the plural photo files M1˜Mn to different virtual folder Fv1˜Fv2.

The storage element 421 is included in the digital media server 42 for storing the plural photo files M1˜Mn. The plural photo files M1˜Mn are stored in a default photo folder Fp of the storage element 421. The data acquisition module 422 is included in the digital media server 42 and connected with the storage element 421 for acquiring at least one business card data and photo data of all photo files. The controlling unit 423 is connected to the data acquisition module 422 and the storage element 421. According to the acquiring result of the data acquisition module 422, the controlling unit 423 writes the at least one business card data and the photo data into the metadata of corresponding photo files. Alternatively, the controlling unit 423 only writes the photo data into the metadata of the photo files. Consequently, the plural photo files M1˜Mn are assigned to different virtual folders Fv1˜Fv2. In this embodiment, the storage element 421 is a hard disc in the digital media server 42, and the controlling unit 423 is a microprocessor. Alternatively, in some other embodiments, the storage element is a flash drive or a portable hard disc drive that can be plugged into the digital media server. Alternatively, the storage element is a network storage space that is in communication with the digital media server through network connection.

It is noted that each photo file contain photo data. For example, the photo data includes the file name, the file size, the photo resolution information, the photo height information and the photo width information. Among the plural photo files M1˜Mn, only the photo files corresponding to the physical business cards contain the business card data. The business card data includes the company trademark information, the name information, the company name information, the professional title information, the e-mail information, the address information, the phone numbers and the fax number information. That is, the photo files that are not obtained by capturing or scanning physical business cards only contain the photo data but do not contain the business card data.

The active control device 43 is connected to the network router 41 through network connection. Moreover, via the network router 41, the active control device 43 is connected with the digital media server 42 through network connection. The active control device 43 comprises a display screen 431 and an operation interface 432. The plural photo files M1˜Mn stored in the storage element 421 may be displayed on the display screen 431. Via the operation interface 432, the user may operate the plural photo files M1˜Mn in order to generate corresponding operation commands. In this embodiment, the network router 41, the digital media server 42 and the active control device 43 are collaboratively defined as an area network 40. In this embodiment, the active control device 43 is a digital media player. The display screen 431 and the operation interface 432 are combined as a touch screen. Moreover, the network router 41 complies with the universal plug and play (UPnP) protocol. Moreover, both of the digital media server 42 and the active control device 43 comply with the Digital Living Network Alliance (DLNA) protocol.

Hereinafter, a photo media displaying method according to the present invention will be illustrated with reference to FIG. 5. FIG. 5 is a flowchart illustrating a photo media displaying method for displaying photo files in an area network according to a first embodiment of the present invention. The photo media displaying method comprises the following steps.

In a step A, the digital media server of the area network judges whether at least one business card data is acquired from plural received photo files. In a step B, the digital media server writes the at least one business card data and plural photo data of the plural photo files into plural metadata of the plural photo files according to the result of acquiring the at least one business card data. In a step C, the plural photo files are assigned to a first virtual folder or a second virtual folder of the digital media server according to the contents of the at least one business card data. In a step D, if the first virtual folder or the second virtual folder is selected through the active control device of the area network, the photo files corresponding to the first virtual folder or the photo files corresponding to the second virtual folder are displayed on the active control device.

The step A comprises the following steps A1, A2 and A3. In the step A1, the digital media server detects whether the plural photo files are received. In the step A2, the digital media server performs a data acquisition to acquire the at least one business card data from the plural photo files. In the step A3, the digital media server judges whether the at least one business card data is acquired from the plural photo files according to the result of the data acquisition.

If the digital media server judges that no photo files are received in the step A1, the step A1 is repeatedly done. If the digital media server judges that the plural photo files are received in the step A1, the step A2 is performed.

The step B comprises the following steps B1 and B2. In the step B1, the digital media server acquires the corresponding photo data and writes plural business card data and the corresponding photo data into the corresponding metadata, so that the corresponding photo files are assigned to the first virtual folder of the digital media server. In the step B2, the digital media server acquires the corresponding photo data and writes the corresponding photo data into the corresponding metadata, so that the corresponding photo files are assigned to the second virtual folder of the digital media server.

The step C comprises the following steps C1 and C2. In the step C1, the corresponding photo files are assigned to the first virtual folder of the digital media server, and a “business card type” is designated as a first folder name of the first virtual folder by the digital media server. In the step C2, the corresponding photo files are assigned to the second virtual folder of the digital media server, and a “non-business card type” is designated as a second folder name of the second virtual folder by the digital media server.

The step D comprises the following steps D1 and D2. In the step D1, the active control device retrieves the photo files corresponding to the first virtual folder from the digital media server (Step D1-1), and the photo files corresponding to the first virtual folder are transmitted from the digital media server to the active control device in response to a first retrieve request from the active control device, so that the photo files corresponding to the first virtual folder are displayed on the active control device (Step D1-2). In the step D2, the active control device retrieves the photo files corresponding to the second virtual folder from the digital media server (Step D2-1), and the photo files corresponding to the second virtual folder are transmitted from the digital media server to the active control device in response to a second retrieve request from the active control device, so that the photo files corresponding to the second virtual folder are displayed on the active control device (Step D2-2).

The metadata of the photo file describes the data property in order to indicate the storage location, the history data, the resource search, the file record or any other appropriate information. In other words, the metadata is an electronic list for achieving a list editing function. The metadata describes the contents or the features of the photo file in order to facilitate searching the photo file.

Hereinafter, the detailed procedures of the photo media displaying method performed by the photo media displaying system 4 will be illustrated with reference to FIGS. 4 and 5. Firstly, in the step A1, the controlling unit 423 judges whether the plural photo files are received by detecting whether newly-received photo files are stored in the storage element 421. If the plural photo files M1˜Mn are stored in the storage element 421, the judging condition of the step A1 is satisfied and then the controlling unit 423 performs the step A2. Whereas, if the judging condition of the step A1 is not satisfied, the controlling unit 423 repeatedly judges whether the plural photo files are received until the judging condition of the step A1 is satisfied. In the step A2, the data acquisition module 422 performs a data acquisition to acquire at least one business card data from the plural photo files M1˜Mn successively. For example, the data acquisition module 422 can acquire corresponding business card data Ic1˜Ic5 from the photo files M1˜M5, but the data acquisition module 422 cannot acquire business card data from the photo files M6˜Mn. The business card data Ic1 corresponds to the photo file M1; the business card data Ic2 corresponds to the photo file M2; the business card data Ic3 corresponds to the photo file M3; the business card data Ic4 corresponds to the photo file M4; and the business card data Ic5 corresponds to the photo file M5. In the step A3, according to the result of acquiring the business card data, the controlling unit 423 judges that the business card data Ic1˜1c5 are acquired from the photo files M1˜M5 but no business card data are acquired from the photo files M6˜Mn.

After the step A, the step B1 is performed. In the step B1, the data acquisition module 422 acquires the corresponding photo data Id1˜Id5 from the photo files M1˜M5. The photo data Id1 corresponds to the photo file M1; the photo data Id2 corresponds to the photo file M2; the photo data Id3 corresponds to the photo file M3; the photo data Id4 corresponds to the photo file M4; and the photo data Id5 corresponds to the photo file M5. After the corresponding photo data Id1˜Id5 are acquired by the data acquisition module 422, the controlling unit 423 writes the business card data Ic1˜Ic5 and the photo data Id1˜Id5 into corresponding metadata MD1˜MD5 of the photo files M1˜M5, respectively. Since all of the metadata MD1˜MD5 contain the business card data Ic1˜Ic5, the photo files M1˜M5 are assigned to the first virtual folder Fv1 of the digital media server 42 by the controlling unit 423 in the step C1. In addition, a “business card type” is designated as a first folder name of the first virtual folder Fv1 by the controlling unit 423.

In the step B2, the data acquisition module 422 acquires corresponding photo data Id6˜Idn from the photo files M6˜Mn. The photo data Id6 corresponds to the photo file M6. The photo data Id7 corresponds to the photo file M7. The photo data Idn corresponds to the photo file Mn. The rest may be deduced by analogy. After the corresponding photo data Id6˜Idn are acquired by the data acquisition module 422, the controlling unit 423 writes the photo data Id6˜Idn into corresponding metadata MD6˜MDn of the photo files M6˜Mn, respectively. Since no business card data are contained in the metadata MD6˜MDn, the photo files M6˜Mn are assigned to the second virtual folder Fv2 of the digital media server 42 by the controlling unit 423 in the step C2. In addition, a “non-business card type” is designated as a second folder name of the second virtual folder Fv2 by the controlling unit 423.

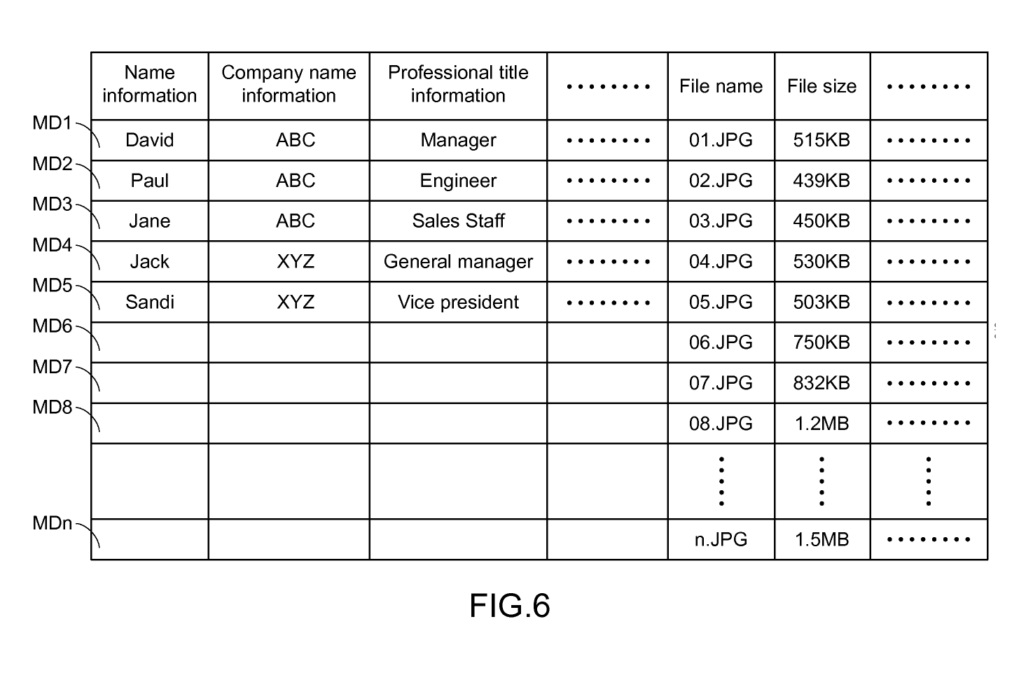

FIG. 6 is a table indicating the metadata of the plural photo files of the photo media displaying system of the present invention. The contents of the plural metadata MD1˜MDn corresponding to the photo files M1˜Mn are shown in FIG. 6. The file name of the photo file M1 is 01.JPG. The file name of the photo file M2 is 02.JPG. The file name of the photo file Mn is n.JPG. The rest may be deduced by analogy. For clarification and brevity, only the name information, the company name information, the professional title information of the business card data and the file name and the file size of the photo data are shown in FIG. 6. That is, the e-mail information, the address information, the phone number information and the fax number information of the business card data and the photo resolution information, the photo height information and the photo width information of the photo data are omitted. In fact, the above business card data and the above photo data are all contained in the plural metadata MD1˜MDn.

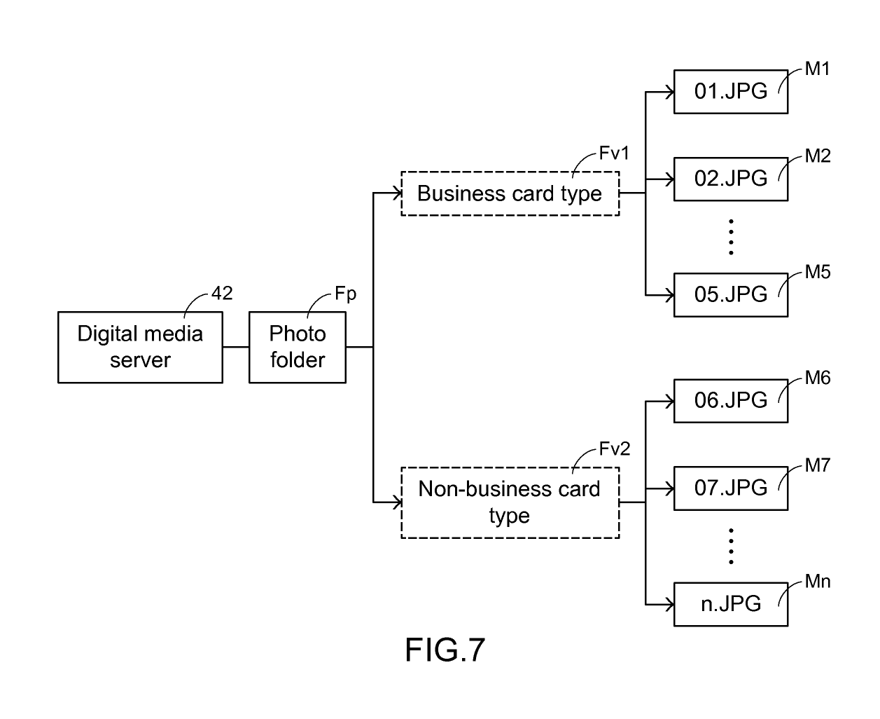

Consequently, by judging whether the photo files M1˜Mn contains the business card data, the controlling unit 423 may determine whether the photo files M1˜Mn belong to the business card type or the non-business card type. Consequently, the photo files M1˜M5 and the photo files M6˜Mn are assigned to different virtual folders according to different types of the photo files. The following two aspects should be specially described. Firstly, the photo folder Fp corresponding to the photo files, a video folder corresponding to the video files and an audio folder corresponding to the audio files are previously stored in the storage element 421. Since the present invention is directed to the photo files, only the photo folder Fp is shown in FIG. 7. Secondly, the “business card type” is designated as the first folder name of the first virtual folder Fv1 in the step C1, and the “non-business card type” is designated as the second folder name of the second virtual folder Fv2 in the step C2. It is noted that numerous modifications and alterations may be made while retaining the teachings of the invention. In another embodiment, in the step C1, the name information, the company name information, the professional title information, the e-mail information, the address information, the phone numbers or the fax number information of the business card data may be designated as the first folder name of the first virtual folder Fv1.

As shown in FIG. 6, the data belonging to the business card type are written into the data fields of the metadata MD1˜MD5, and the data belonging to the non-business card type are written into the data fields of the metadata MD6˜MDn. As shown in FIG. 7, the photo files assigned to the first virtual folder Fv1 include the photo files M1˜M5, and the first virtual folder Fv1 is correlated with the photo files M1˜M5 corresponding to the business card type. In addition, the photo files assigned to the second virtual folder Fv2 include the photo files M6˜Mn, and the second virtual folder Fv2 is correlated with the photo files M6˜Mn corresponding to the non-business card type. In other words, the photo files M1˜M5 corresponding to the business card type are assigned to the first virtual folder Fv1, and the photo files M6˜Mn corresponding to the non-business card type are assigned to the second virtual folder Fv2.

Next, the active control device 43 is connected to the digital media server 42 via the network router 41 through network connection. Consequently, the plural photo files M1˜Mn are classified into two groups by the controlling unit 423 of the digital media server 42 according to the data fields of the plural metadata MD1˜MDn. The photo files with the business card data (i.e. the business card type) belong to the first group, and the photo files without the business card data (i.e. the non-business card type) belong to the second group. According to the above classification, the controlling unit 423 generates a folder packet Pc. The folder packet Pc is transmitted to the active control device 43. According to the folder packet Pc, the first virtual folder Fv1 and the second virtual folder Fv2 are displayed on the display screen 431 of the active control device 43.

Then, in the step D1-1, if the first virtual folder Fv1 is selected by the user via the operation interface 432 of the active control device 43, the active control device 43 issues a first retrieve request R1 corresponding to the first virtual folder Fv1 to the digital media server 42 in order to retrieve the photo files M1˜M5 corresponding to the first virtual folder Fv1 from the digital media server 42. In response to the first retrieve request R1, the photo files M1˜M5 containing the business card data are retrieved and formed as a first list packet P1 by the controlling unit 423, and the first list packet P1 is transmitted to the active control device 43. In response to the first list packet P1, the photo files M1˜M5 corresponding to the first virtual folder Fv1 are displayed on the display screen 431 of the active control device 43. That is, the step D1-2 is performed. For example, the website address of the photo file M1 displayed on the active control device 43 is http:\\DMS\Photo\Business-card\01.JPG. The term “DMS” denotes the device name of the digital media server 42. The term “Photo” denotes the folder name of the photo folder Fp. The term “Business-card” denotes the folder name of the first virtual folder corresponding to the business card type. The term “01.JPG” denotes the file name of the photo file M1. The rest of the photo folders M2˜M5 may be deduced by analogy. Of course, when the photo file M1 is selected by the user via the operation interface 432, the image of the photo file M1 is displayed on the display screen 431 to be viewed by the user.

Whereas, in the step D2-1, if the second virtual folder Fv2 is selected by the user via the operation interface 432 of the active control device 43, the active control device 43 issues a second retrieve request R2 corresponding to the second virtual folder Fv2 to the digital media server 42 in order to retrieve the photo files M6˜Mn corresponding to the second virtual folder Fv2 from the digital media server 42. In response to the second retrieve request R2, the photo files M6˜Mn without the business card data are retrieved and formed as a second list packet P2 by the controlling unit 423, and the second list packet P2 is transmitted to the active control device 43. In response to the second list packet P2, the photo files M6˜Mn corresponding to the second virtual folder Fv2 are displayed on the display screen 431 of the active control device 43. That is, the step D2-2 is performed. For example, the website address of the photo file M6 displayed on the active control device 43 is http:\\DMS\Photo\Non-business-card\06.JPG. The term “Non-business-card” denotes the folder name of the second virtual folder corresponding to the non-business card type. The term “06.JPG” denotes the file name of the photo file M6. The rest of the photo folders M7˜Mn may be deduced by analogy. Of course, when the photo file M6 is selected by the user via the operation interface 432, the image of the photo file M6 is displayed on the display screen 431 to be viewed by the user. Meanwhile, the photo media displaying method of displaying the photo files in the area network is completed.

FIG. 7 schematically illustrates the folder architecture of the digital media server of the photo media displaying system according to the first embodiment of the present invention. As shown in FIG. 7, the digital media server 42 contains the photo folder Fp. The photo folder Fp contains the first virtual folder Fv1 with the folder name of “business card type” and the second virtual folder Fv2 with the folder name of “non-business card type”. The photo files M1˜M5 are included in the first virtual folder Fv1. The photo files M6˜Mn are included in the second virtual folder Fv2. In fact, the photo files M1˜M5 are not stored in the first virtual folder Fv1, and the photo files M6˜Mn are not stored in the second virtual folder Fv2. In other words, the first virtual folder Fv1 and the second virtual folder Fv2 are temporarily generated by the photo media displaying system 4 of the present invention in order to classify the plural photo files M1˜Mn. Consequently, the user can easily search the desired photo file. In fact, the first virtual folder Fv1 and the second virtual folder Fv2 are not present in the storage element 421, but only displayed on the display screen 431 of the active control device 43.

In the above embodiment, the plural photo files M1˜Mn are stored in the photo folder Fp of the storage element 421. For example, the website of the photo file M1 stored in the photo folder Fp is http:\\DMS\Photo\01.JPG rather than http:\\DMS\Photo\\Business-card\01.JPG, which is displayed on the active control device 43. The rest of the photo folders M2˜Mn may be deduced by analogy.

In the above embodiment of the photo media displaying system 4 of the present invention, the storage element has the default photo folder. Alternatively, in some other embodiments of the photo media displaying system of the present invention, the storage element does not have the default photo folder.

From the above descriptions, the photo media displaying system 4 of the present invention is capable of classifying the plural photo files M1˜Mn by implementing the photo media displaying method of the present invention. The folder architecture of the digital media server 42 is clearly shown in FIG. 7. The first storage element 421 of the digital media server 42 contains the really-existing photo folder Fp. The photo folder Fp contains the first virtual folder Fv1 (indicated by dotted lines) and the second virtual folder Fv2 (indicated by dotted lines), which are practically non-existing. That is, the digital media server 42 only contains the photo folder Fp. For facilitating the user to search the desired photo file, the first virtual folder Fv1 and the second virtual folder Fv2 that do not exist in the digital media server 42 are further displayed on the display screen 431 of the active control device 43. Consequently, the photo media displaying method of the present invention is capable of classifying the plural photo files M1˜Mn.

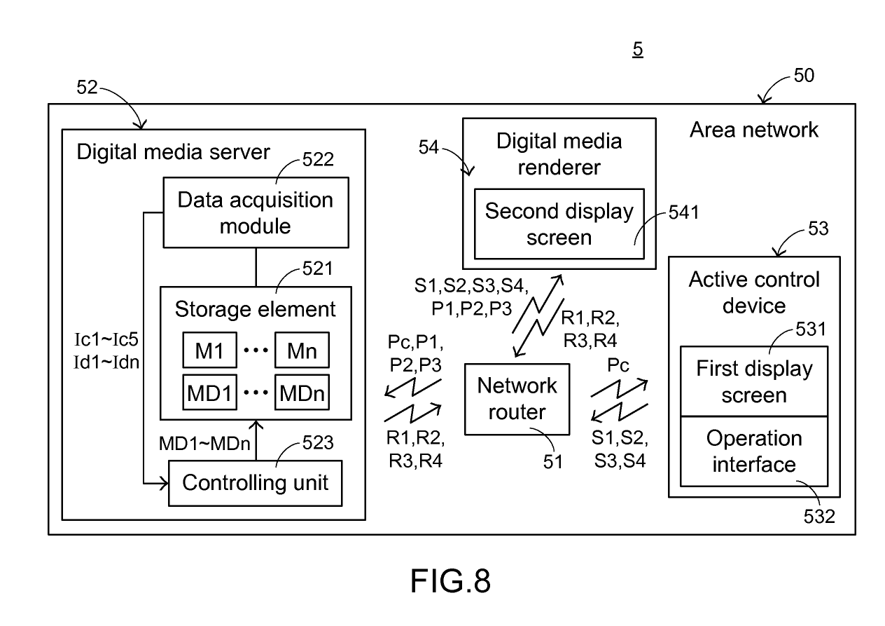

The present invention further provides a second embodiment, which is distinguished from the first embodiment. FIG. 8 is a schematic functional block diagram illustrating a photo media displaying system according to a second embodiment of the present invention. As shown in FIG. 8, the photo media displaying system 5 comprises a network router 51, a digital media server 52, an active control device 53, and a digital media renderer 54. The digital media server 52 comprises a storage element 521, a data acquisition module 522, and a controlling unit 523. The active control device 53 comprises a first display screen 531 and an operation interface 532. The digital media renderer 54 comprises a second display screen 541. In this embodiment, the network router 51, the digital media server 52, the active control device 53 and the digital media renderer 54 are collaboratively defined as an area network 50. Except for the following three aspects, the architecture of the photo media displaying system 5 of this embodiment is identical to the architecture of the photo media displaying system 4 of the first embodiment, and is not redundantly described herein. Firstly, the photo media displaying system 5 further comprises the digital media renderer 54, and the active control device 53 is a digital media controller. Secondly, the storage element 521 of the digital media server 52 is connected with the digital media server 52, but is not installed in the digital media server 52. For example, the storage element 521 is a portable hard disc or a flash drive. Thirdly, the operations of the controlling unit 523 of the digital media server 52 are distinguished. The above features will be illustrated as follows.

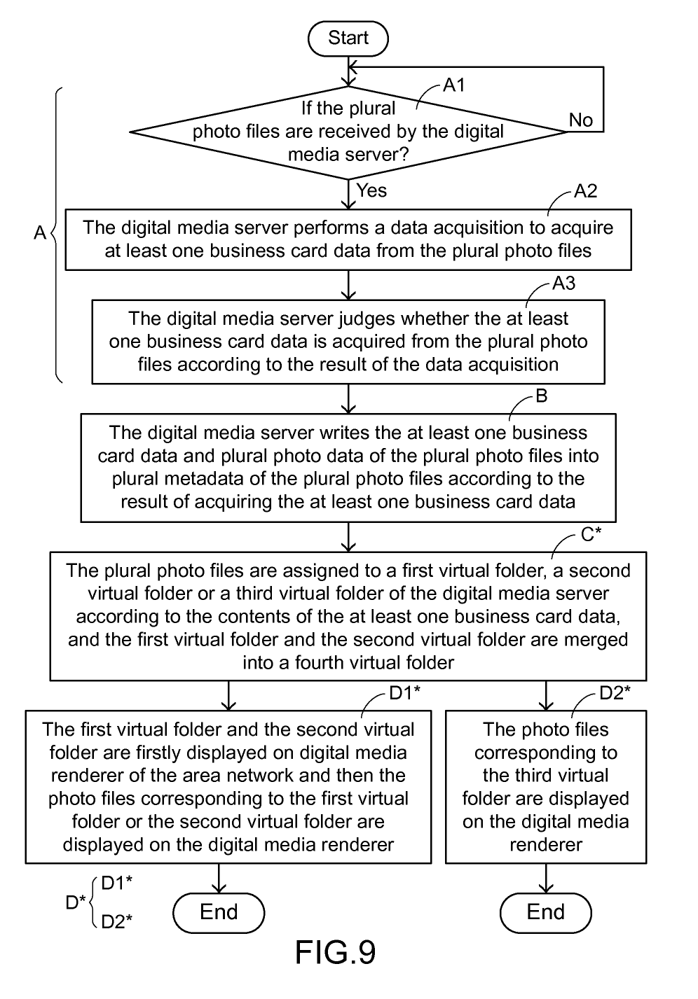

FIG. 9 is a flowchart illustrating a photo media displaying method for displaying photo files in the area network according to a second embodiment of the present invention. The photo media displaying method comprises the following steps.

In a step A, the digital media server of the area network judges whether at least one business card data is acquired from plural received photo files. In the step B, the digital media server writes the at least one business card data and plural photo data of the plural photo files into plural metadata of the plural photo files according to the result of acquiring the at least one business card data. In a step C*, the plural photo files are assigned to a first virtual folder, a second virtual folder or a third virtual folder of the digital media server according to the contents of the at least one business card data, and the first virtual folder and the second virtual folder are merged into a fourth virtual folder. In a step D*, according to a selecting action through the active control device of the area network, the first virtual folder and the second virtual folder are firstly displayed on digital media renderer of the area network and then the photo files corresponding to the first virtual folder or the second virtual folder are displayed on the digital media renderer, or the photo files corresponding to the third virtual folder are displayed on the digital media renderer.

The step A and the step B of the photo media displaying method implemented by the photo media displaying system 5 of this embodiment are similar to those of the first embodiment, but the operations of the step C* and the step D* are distinguished.

The step C* comprises the following steps C1*, C2*, C3*, C4* and C5*. In the step C1*, the photo files corresponding to a first company name information are assigned to the first virtual folder of the digital media server, and the first company name information is designated as a first folder name of the first virtual folder by the digital media server. In the step C2*, the photo files corresponding to a second company name information are assigned to the second virtual folder of the digital media server, and the second company name information is designated as a second folder name of the second virtual folder by the digital media server. In the step C3*, a fourth virtual folder is established, and a company type corresponding to the company name information is correlated with the fourth virtual folder. In the step C4*, the first virtual folder and the second virtual folder are merged into the fourth virtual folder. In the step C5*, the corresponding photo files are assigned to the third virtual folder of the digital media server, and the non-business card type is designated as a third folder name of the third virtual folder by the digital media server.

The step D* comprises the following steps D1* and D2*. The step D1* comprises the steps D1-1*, D1-2*, D1-3*, D1-4*, D1-5* and D1-6*. In the step D1-1*, a first retrieve request corresponding to the fourth virtual folder is transmitted from the digital media renderer to the digital media server. In the step D1-2*, a first list packet corresponding to the first virtual folder and the second virtual folder is transmitted from the digital media server to the digital media renderer in response to the first retrieve request corresponding to the fourth virtual folder, so that the first virtual folder and the second virtual folder are displayed on the digital media renderer. In the step D1-3*, the digital media renderer retrieves the photo files corresponding to the first virtual folder from the digital media server. In the step D1-4*, the corresponding photo files are transmitted from the digital media server to the digital media renderer in response to a second retrieve request corresponding to the first virtual folder, so that the photo files corresponding to the first virtual folder are displayed on the digital media renderer. In the step D1-5*, the digital media renderer retrieves the photo files corresponding to the second virtual folder from the digital media server. In the step D1-6*, the corresponding photo files are transmitted from the digital media server to the digital media renderer in response to a third retrieve request corresponding to the second virtual folder, so that the photo files corresponding to the second virtual folder are displayed on the digital media renderer. In the step D2*, the digital media renderer retrieves the photo files corresponding to the third virtual folder from the digital media server (Step D2-1*), and the photo files corresponding to the third virtual folder are transmitted from the digital media server to the digital media renderer in response to a fourth retrieve request from the digital media renderer, so that the photo files corresponding to the third virtual folder are displayed on the digital media renderer (Step D2-2*).

The detailed procedures of the photo media displaying method performed by the photo media displaying system 5 will be illustrated as follows. After the photo files M1˜M5 are received by the digital media server 52, the step A and the step B as described in the first embodiment are performed. That is, the data acquisition module 522 acquires corresponding business card data Ic1˜Ic5 and corresponding photo data Id1˜Id5 from the photo files M1˜M5, and the controlling unit 523 writes the business card data Ic1˜Ic5 and the photo data Id1˜Id5 into corresponding metadata MD1˜MD5 of the photo files M1˜M5, respectively. The data acquisition module 522 cannot acquire business card data from the photo files M6˜Mn. That is, the data acquisition module 522 only acquires corresponding photo data Id6˜Idn from the photo files M6˜Mn. The controlling unit 523 writes the photo data Id6˜Idn into corresponding metadata MD6˜MDn of the photo files M6˜Mn, respectively. Similarly, the contents of the plural metadata MD1˜MDn corresponding to the photo files M1˜Mn are shown in FIG. 6.

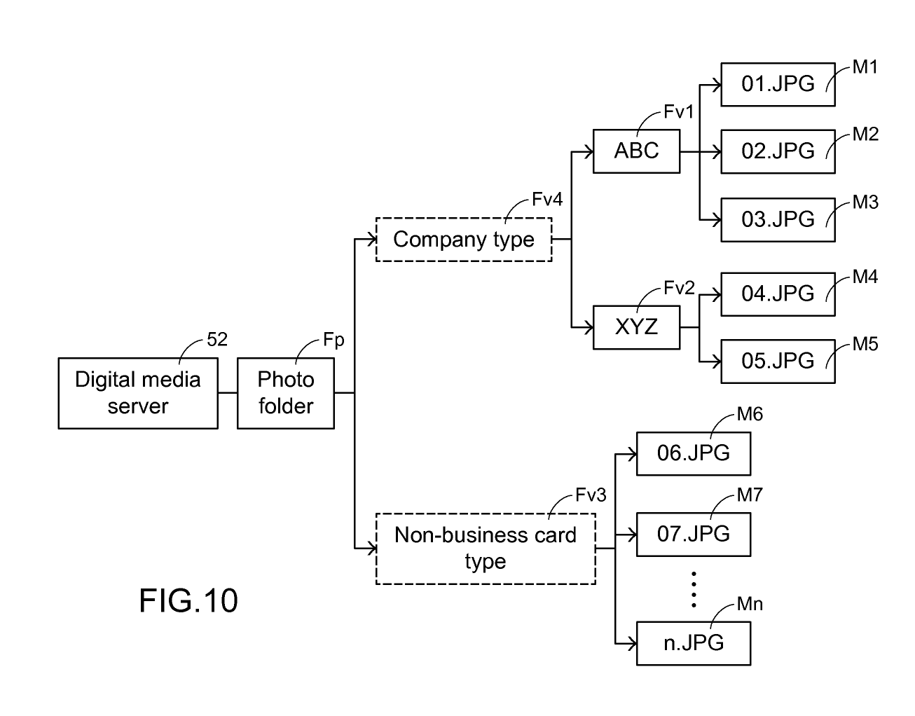

After the step B, the controlling unit 523 acquires a first company name information (e.g. ABC Company) from the business card data Ic1˜1c3 and acquires a second company name information (e.g. XYZ Company) from the business card data Ic4˜1c5. In the step C1*, the photo files M1˜M3 are assigned to the first virtual folder Fv1 of the digital media server 52 by the controlling unit 523, and the first company name information is designated as a first folder name of the first virtual folder Fv1 by the controlling unit 523. For example, the first company name information is ABC Company (see FIG. 10). In the step C2*, the photo files M4˜M5 are assigned to the second virtual folder Fv2 of the digital media server 52 by the controlling unit 523, and the second company name information is designated as a second folder name of the second virtual folder Fv2 by the controlling unit 523. For example, the second company name information is XYZ Company (see FIG. 10). In the step C3*, a fourth virtual folder Fv4 is established in the photo folder Fp of the storage element 521 by the controlling unit 523, and a company type corresponding to the company name information is correlated with the fourth virtual folder Fv4. In the step C4*, the first virtual folder Fv1 and the second virtual folder Fv2 are merged into the fourth virtual folder Fv4 by the controlling unit 523.

Since no business card data are contained in the metadata MD6˜MDn, the photo files M6˜Mn are assigned to the third virtual folder Fv3 of the digital media server 52 by the controlling unit 523 in the step C5*. In addition, a “non-business card type” is designated as a third folder name of the third virtual folder Fv3 by the controlling unit 523.

Next, the active control device 53 is connected to the digital media server 52 via the network router 51 through network connection. Consequently, the controlling unit 523 generates a folder packet Pc corresponding to the third virtual folder Fv3 and the fourth virtual folder Fv4, and issues the folder packet Pc to the digital media renderer 54. According to the folder packet Pc, the third virtual folder Fv3 and the fourth virtual folder Fv4 are displayed on the second display screen 541 of the digital media renderer 54.

Next, in the step D1-1*, if the fourth virtual folder Fv4 is selected by the user via the operation interface 532 of the active control device 53, the active control device 53 issues a control command S1 corresponding to the fourth virtual folder Fv4 to the digital media renderer 54. The control command S1 contains the website address information of the digital media server 52. According to the website address information of the digital media server 52, the digital media renderer 54 issues a first retrieve request R1 corresponding to the fourth virtual folder Fv4 to the digital media server 52. Then, in response to the first retrieve request R1, a first list packet P1 corresponding to the first virtual folder Fv1 and the second virtual folder Fv2 is generated by the controlling unit 523, and the first list packet P1 is transmitted to the digital media renderer 54, so that the first list packet P1 corresponding to the first virtual folder Fv1 and the second virtual folder Fv2 is displayed on the second display screen 541 of the digital media renderer 54 (Step D1-2*).

In the step D1-3*, if the first virtual folder Fv1 is selected by the user via the operation interface 532, the active control device 53 issues a control command S2 corresponding to the first virtual folder Fv1 to the digital media renderer 54. The control command S2 contains the website address information of the digital media server 52. According to the website address information of the digital media server 52, the digital media renderer 54 issues a second retrieve request R2 corresponding to the first virtual folder Fv1 to the digital media server 52 in order to retrieve the photo files M1˜M3 corresponding to the first virtual folder Fv1 from the digital media server 52. In response to the second retrieve request R2, the photo files M1˜M3 corresponding to the first virtual folder Fv1 are retrieved and formed as a second list packet P2 by the controlling unit 523, and the second list packet P2 is transmitted to the digital media renderer 54, so that the photo files M1˜M3 corresponding to the first virtual folder Fv1 are displayed on the second display screen 541 of the digital media renderer 54 (Step D1-4*). Of course, if the photo file M1 is selected by the user via the operation interface 532, the photo file M1 is displayed on the second display screen 541 to be viewed by the user.

In the step D1-5*, if the second virtual folder Fv2 is selected by the user via the operation interface 532, the active control device 53 issues a control command S3 corresponding to the second virtual folder Fv2 to the digital media renderer 54. The control command S3 contains the website address information of the digital media server 52. According to the website address information of the digital media server 52, the digital media renderer 54 issues a third retrieve request R3 corresponding to the second virtual folder Fv2 to the digital media server 52 in order to retrieve the photo files M4˜M5 corresponding to the second virtual folder Fv2 from the digital media server 52. In response to the third retrieve request R3, the photo files M4˜M5 corresponding to the second virtual folder Fv2 are retrieved and formed as a third list packet P3 by the controlling unit 523, and the third list packet P3 is transmitted to the digital media renderer 54, so that the photo files M4˜M5 corresponding to the second virtual folder Fv2 are displayed on the second display screen 541 of the digital media renderer 54 (Step D1-6*). Of course, if the photo file M5 is selected by the user via the operation interface 532, the photo file M5 is displayed on the second display screen 541 to be viewed by the user.

In the step D2-1*, if the third virtual folder Fv3 is selected by the user via the operation interface 532, the active control device 53 issues a control command S4 corresponding to the third virtual folder Fv3 to the digital media renderer 54. The control command S4 contains the website address information of the digital media server 52. According to the website address information of the digital media server 52, the digital media renderer 54 issues a fourth retrieve request R4 corresponding to the third virtual folder Fv3 to the digital media server 52 in order to retrieve the photo files M6˜Mn corresponding to the third virtual folder Fv3 from the digital media server 52. In response to the fourth retrieve request R4, the photo files M6˜Mn corresponding to the third virtual folder Fv3 are retrieved and formed as a fourth list packet P4 by the controlling unit 523, and the fourth list packet P4 is transmitted to the digital media renderer 54, so that the photo files M6˜Mn corresponding to the third virtual folder Fv3 are displayed on the second display screen 541 of the digital media renderer 54 (Step D2-2*). Of course, if the photo file Mn is selected by the user via the operation interface 532, the photo file Mn is displayed on the second display screen 541 to be viewed by the user.

FIG. 10 schematically illustrates the folder architecture of the digital media server of the photo media displaying system according to the second embodiment of the present invention. As shown in FIG. 10, the digital media server 52 contains the photo folder Fp. The photo folder Fp contains the fourth virtual folder Fv4 with the folder name of “company type” and the third virtual folder Fv3 with the folder name of “non-business card type”. The first virtual folder Fv1 and the second virtual folder Fv2 are included in the fourth virtual folder Fv4. The file name of the photo file M1 is 01.JPG. The file name of the photo file M2 is 02.JPG. The file name of the photo file Mn is n.JPG. The rest may be deduced by analogy.

The photo files M1˜M3 are included in the first virtual folder Fv1 corresponding to the first company name information. The photo files M4˜M5 are included in the second virtual folder Fv2 corresponding to the second company name information. The photo files M6˜Mn are included in the third virtual folder Fv3 corresponding to the non-business card type. In fact, the photo files M1˜M3 are not stored in the first virtual folder Fv1, the photo files M4˜M5 are not stored in the second virtual folder Fv2, and the photo files M6˜Mn are not stored in the third virtual folder Fv3. In other words, the first virtual folder Fv1, the second virtual folder Fv2 and the third virtual folder Fv3 are temporarily generated by the photo media displaying system 5 of the present invention in order to classify the plural photo files M1˜Mn. Consequently, the user can easily search the desired photo file. In fact, the first virtual folder Fv1, the second virtual folder Fv2, the third virtual folder Fv3 and the fourth virtual folder Fv4 are not present in the storage element 521, but only displayed on the second display screen 541 of the digital media renderer 54.

The following two aspects should be specially described. Firstly, the digital media renderer 54 of this embodiment is a large-sized digital television, so that the photo file M1 displayed on the second display screen 541 can be viewed by many users. Secondly, the folder names of different virtual folders may be established by different settings of the controlling unit 523 according to different classification types. In this embodiment, the fourth virtual folder Fv4 is classified according to the company type corresponding to the company name information. Moreover, the first virtual folder Fv1 and the second virtual folder Fv2 that are merged into the fourth virtual folder Fv4 are correlated with the first company name information and the second company name information, respectively. Alternatively, in some other embodiments, the following settings are established. Firstly, the fourth virtual folder Fv4 is classified according to the name type corresponding to the name information, and the first virtual folder Fv1 and the second virtual folder Fv2 that are merged into the fourth virtual folder Fv4 are correlated with a first name information (e.g. David) and a second name information (e.g. Paul), respectively. Secondly, the fourth virtual folder Fv4 is classified according to the professional title type corresponding to the professional title information, and the first virtual folder Fv1 and the second virtual folder Fv2 that are merged into the fourth virtual folder Fv4 are correlated with a first professional title information (e.g. Engineer) and a second professional title information (e.g. Manager), respectively.

From the above descriptions, the present invention provides a photo media displaying system and a photo media displaying method for displaying photo files in an area network. According to the contents of the received photo files, the photo files are classified, and the plural metadata of plural photo files are set. When the user operates an active control device or a digital media renderer to browse plural photo files, the plural virtual folders after classification are displayed on the active control device or the digital media renderer according to the contents of the metadata. Each of the virtual folders contains the corresponding photo files. Consequently, the photo files with the same type or the same business card data are assigned to the same virtual folder in order to be viewed by the user more easily. In other words, the photo media displaying system of the present invention can classify and manage the photo files in order to facilitate the user to browse the photo files.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo media displaying method for use in an area network, the photo media displaying method comprising steps of:
(A) a digital media server of the area network judging whether at least one business card data is acquired from plural photo files;
(B) the digital media server writing the at least one business card data and plural photo data of the plural photo files into plural metadata of the plural photo files or writing only the plural photo data of the plural photo files into the plural metadata of the plural photo files according to a result of acquiring the at least one business card data;
(C) allowing the plural photo files to be assigned to a first virtual folder or a second virtual folder of the digital media server according to contents of the at least one business card data; and
(D) if an active control device of the area network is connected to the digital media server through network connection and the first virtual folder or the second virtual folder is selected, displaying the photo files corresponding to the first virtual folder and the second virtual folder on the active control device or a digital media renderer of the area network.

2. The photo media displaying method according to claim 1, wherein the step (A) comprises steps of:
(A1) the digital media server detecting whether the plural photo files are received;
(A2) if the plural photo files are received by the digital media server, performing a data acquisition to acquire the at least one business card data from the plural photo files; and
(A3) the digital media server judging whether the at least one business card data is acquired from the plural photo files.

3. The photo media displaying method according to claim 1, wherein the step (D) comprises steps of:
(D1) the active control device or the digital media renderer retrieving the photo files corresponding to the first virtual folder from the digital media server; and
(D2) transmitting the photo files corresponding to the first virtual folder from the digital media server to the active control device or the digital media renderer in response to a first retrieve request from the active control device or the digital media renderer, so that the photo files corresponding to the first virtual folder are displayed on the active control device or the digital media renderer; or
the step (D) comprises steps of:
(D3) the active control device or the digital media renderer retrieving the photo files corresponding to the second virtual folder from the digital media server; and
(D4) transmitting the photo files corresponding to the second virtual folder from the digital media server to the active control device or the digital media renderer in response to a second retrieve request from the active control device or the digital media renderer, so that the photo files corresponding to the second virtual folder are displayed on the active control device or the digital media renderer.

4. The photo media displaying method according to claim 1, wherein the step (B) comprises steps of:
(B1) if plural business card data are acquired from the plural photo files, the digital media server acquiring the corresponding photo data and writing the plural business card data and the corresponding photo data into corresponding metadata; and
(B2) if no business card data are acquired from the plural photo files, the digital media server acquiring corresponding photo data and writing the corresponding photo data into corresponding metadata; and
the step (C) comprises steps of:
(C1) if the plural business card data are contained in corresponding metadata, assigning the corresponding photo files to the first virtual folder of the digital media server and designating a business card type as a first folder name of the first virtual folder; and
(C2) if no business card data are contained in corresponding metadata, assigning the corresponding photo files to the second virtual folder of the digital media server and designating a non-business card type as a second folder name of the second virtual folder.

5. The photo media displaying method according to claim 1, wherein the step (B) comprises steps of:
(B1) if plural business card data are acquired from the plural photo files, the digital media server acquiring the corresponding photo data and writing the business card data and the corresponding photo data into corresponding metadata; and
(B2) if no business card data are acquired from the plural photo files, the digital media server acquiring corresponding photo data and writing the corresponding photo data into corresponding metadata; and
the step (C) comprises steps of:
(C3) if the plural business card data contain a first name information and a second name information, assigning the photo files corresponding to the first name information to the first virtual folder of the digital media server and designating the first name information as a first folder name of the first virtual folder, and assigning the photo files corresponding to the second name information to the second virtual folder of the digital media server and designating the second name information as a second folder name of the second virtual folder; or
(C4) if the plural business card data contain a first company name information and a second company name information, assigning the photo files corresponding to the first company name information to the first virtual folder of the digital media server and designating the first company name information as the first folder name of the first virtual folder, and assigning the photo files corresponding to the second company name information to the second virtual folder of the digital media server and designating the second company name information as the second folder name of the second virtual folder; or
(C5) if the plural business card data contain a first professional title information and a second professional title information, assigning the photo files corresponding to the first professional title information to the first virtual folder of the digital media server and designating the first professional title information as the first folder name of the first virtual folder, and assigning the photo files corresponding to the second professional title information to the second virtual folder of the digital media server and designating the second professional title information as the second folder name of the second virtual folder.

6. The photo media displaying method according to claim 5, wherein after the step (C3), the step (C4) or the step (C5), the step (C) further comprises steps of:
(C6) establishing a third virtual folder and designing a classification type as the third virtual folder, wherein the classification type comprises a name type corresponding to the first name information and the second name information, a company type corresponding to the first company name information and the second company name information, and a professional title type corresponding to the first professional title information and the second professional title information; and
(C7) merging the first virtual folder and the second virtual folder into the third virtual folder.

7. The photo media displaying method according to claim 6, wherein the step (D) comprises steps of:
(D5) the active control device or the digital media renderer issuing a first retrieve request corresponding to the third virtual folder to the digital media server;
(D6) transmitting a first packet corresponding to the first virtual folder and the second virtual folder from the digital media server to the active control device or the digital media renderer in response to the first retrieve request corresponding to the third virtual folder, so that the first virtual folder and the second virtual folder are displayed on the active control device or the digital media renderer;
(D7) the active control device or the digital media renderer retrieving the photo files corresponding to the first virtual folder or the second virtual folder from the digital media server;
(D8) transmitting the corresponding photo files from the digital media server to the active control device or the digital media renderer in response to a second retrieve request corresponding to the first virtual folder, so that the photo files corresponding to the first virtual folder are displayed on the active control device or the digital media renderer; and
(D9) transmitting the corresponding photo files from the digital media server to the active control device or the digital media renderer in response to a third retrieve request corresponding to the second virtual folder, so that the photo files corresponding to the second virtual folder are displayed on the active control device or the digital media renderer.

8. A photo media displaying system, comprising:
a network router providing a network connection function;
a digital media server connected to the network router through network connection and storing plural photo files, wherein the plural photo files are assigned to a first virtual folder or a second virtual folder of the digital media server, wherein the digital media server comprises:
a storage element disposed within the digital media server or connected with the digital media server, wherein the plural photo files are stored in the storage element;
a data acquisition module connected with the storage element and acquiring at least one business card data and plural photo data from the plural photo files; and
a controlling unit connected with the storage element and the data acquisition module, wherein according to an acquiring result of the data acquisition module, the controlling unit writes the at least one business card data and the plural photo data into plural metadata of the plural photo files or writes the plural photo data into the plural metadata of the plural photo files, so that the plural photo files are selectively assigned to the first virtual folder or the second virtual folder; and
an active control device connected to the network router through network connection and connected to the digital media server via the network router through network connection, wherein the first virtual folder or the second virtual folder is selected through the active control device, wherein if the first virtual folder or the second virtual folder is selected, the photo files corresponding to the first virtual folder or the second virtual folder are retrieved from the digital media server by the active control device or a digital media renderer and displayed on the active control device or the digital media renderer.

9. The photo media displaying system according to claim 8, wherein if the at least one business card data is acquired from the plural photo files by the data acquisition module, the controlling unit acquires the photo data of the corresponding photo files and writes the at least one business card data and the photo data into the plural metadata of the plural photo files, so that the corresponding photo files are assigned to the first virtual folder of the digital media server, wherein if the at least one business card data is not acquired from the plural photo files by the data acquisition module, the controlling unit acquires the photo data of the corresponding photo files and writes the photo data into the plural metadata of the plural photo files, so that the corresponding photo files are assigned to the second virtual folder of the digital media server.

10. The photo media displaying system according to claim 9, wherein the controlling unit judges whether the corresponding photo files belong to a business card type by judging whether the at least one business card data is acquired from the corresponding photo files by the data acquisition module, wherein if the at least one business card data is acquired from the corresponding photo files by the data acquisition module, the controlling unit judges that the corresponding photo files belong to the business card type, wherein if the at least one business card data is not acquired from the corresponding photo files by the data acquisition module, the controlling unit judges that the corresponding photo files belong to a non-business card type.

11. The photo media displaying system according to claim 8, wherein if the first virtual folder or the second virtual folder is selected through the active control device, a retrieve request corresponding to the first virtual folder or the second virtual folder is transmitted from the active control device to the digital media server, and the photo files corresponding to the first virtual folder or the second virtual folder is transmitted from the digital media server to the active control device in response to the retrieve request, so that the corresponding photo files are displayed on the active control device, wherein the active control device is a digital media controller or a digital media player according to a DLNA protocol, the network router complies with a UPnP protocol, and the digital media controller and the digital media player comply with the DLNA protocol, wherein the network router, the digital media server and the active control device are collaboratively defined as an area network.

12. The photo media displaying system according to claim 8, wherein if the first virtual folder or the second virtual folder is selected through the active control device, the active control device issues a control command to the digital media renderer, the digital media renderer issues a retrieve request corresponding to the first virtual folder or the second virtual folder to the digital media server according to the control command, and the plural photo files corresponding to the first virtual folder or the second virtual folder are transmitted from the digital media server to the digital media renderer in response to the retrieve request, so that the corresponding photo files are displayed on the digital media renderer, wherein the active control device is a digital media controller or a digital media player according to a DLNA protocol, the network router complies with a UPnP protocol, and the digital media controller and the digital media player comply with the DLNA protocol, wherein the network router, the digital media server, the active control device and the digital media renderer are collaboratively defined as an area network.
